(19) United States
(12) Patent Application Publication
(10) Pub. No.: US 2020/0210799 A1
(43) Pub. Date: Jul. 2, 2020

(54) LAYERED RFID TAG

(71) Applicant: Hewlett-Packard Development Company, L.P., Spring, TX (US)

(72) Inventors: Ning Ge, Palo Alto, CA (US); Douglas Pederson, Corvallis, OR (US); Robrtto Pereira Silveira, Porto Alegre (BR); Robert lonescu, Palo Alto, CA (US); Jarrid Wittkopf, Palo Alto, CA (US); Helen A Holder, Palo Alto, CA (US)

(73) Assignee: Hewlett-Packard Development Company, L.P., Spring, TX (US)

(21) Appl. No.: 16/615,598

(22) PCT Filed: Sep. 26, 2017
(86) PCT No.: PCT/US2017/053512

§ 371 Date: Nov. 21, 2019

(51) Int. Cl. G06K 19/077; H01P 7/08; H01P 11/00

(52) U.S. Cl. CPC G06K 19/07722; H01P 11/008; H01P 7/082; G06K 19/07773

(57) ABSTRACT

Examples disclosed herein relate to a layered RFID tag. In one implementation, a layered passive chipless RFID tag includes a first conductive layer, a second dielectric layer, and a third conductive layer. The first, second, and third layers may be in a stacked configuration with the second layer between the first layer and the second layer.

### BACKGROUND

An RFID (radio frequency identification) tag may be used to identify a package or other item. An RFID tag may be integrated and/or attached to an item and used to account for or track the item. For example, multiple items may be quickly tracked in a supply chain using RFID tags attached to the individual items. An RFID tag may have a signature electromagnetic resonance that is used to track and/or identify the item with an RFID tag with the signature electromagnetic resonance.

### BRIEF DESCRIPTION OF THE DRAWINGS

The drawings describe example embodiments. The following detailed description references the drawings, wherein:

FIG. 1A is a block diagram illustrating one example of a cross section view of a layered RFID tag.

FIG. 1B is a block diagram illustrating one example of a cross section view of a layered RFID tag.

FIG. 2 is a diagram illustrating one example of an exploded view of a layered RFID tag.

FIGS. 3A and 3B are diagrams illustrating examples of cross section views of layered RFID tags with layers of different thicknesses.

FIG. 4 is a block diagram illustrating one example of a printer to print a layered RFID tag.

FIG. 5 is a flow chart illustrating one example of a method to print a layered RFID tag.

### DETAILED DESCRIPTION

An RFID tag may be used for tracking items, such as in a supply chain. Different types of RFID tags may be selected based on cost and functionality. For example, an RFID tag may be active or passive. An active RFID may include an internal power source, and a passive RFID tag may rely on energy from a reading device. A passive RFID tag may be suitable for package tracking or other applications that do not demand a large amount of energy. A passive RFID may be chipped or chipless. A chipless RFID may be cheaper than a chipped RFID because it does not include a microchip. A chipless RFID may include a radio frequency resonance structure, such as a conductive trace, to emit a signature electromagnetic resonance used for identification.

In one implementation, a chipless passive RFID tag includes a layered resonator portion. An RFID tag with a layered resonator portion may provide a cost effective chipless passive RFID. For example, the RFID may include two conductive layers electrically separated with a dielectric layer in between the conductive layers such that there is no electrical component for communicating between the two conductive layers. A layered RFID resonator may increase the resonance capabilities because the space for the resonator is not limited by the 2D space of the RFID tag. The electromagnetic resonance may be controlled by the dielectric layer material choice and design choice, such as overlap between the conductive layers, the dielectric layer material, and/or the dielectric layer thickness, resulting in more capacitance options. The layered RFID tag may also reduce process control for precision space control for creating the RFID tag.

In one implementation, a layered RFID tag is printed. For example, a printer may print an electro printing fluid, such as electro ink, to create conductive layer and a dielectric printing fluid to create a dielectric layer. The printer may be, for example, a liquid electro-photographic (LEP) printer. A layered RFID tag may be simpler and/or less costly to manufacture, for example, because capacitance may be controlled by overlapping of conductive layers such that a short in a conductive trace on a first level does not eliminate the electromagnetic resonance of the RFID tag. In addition, the passive and chipless characteristics of the RFID tag may make it more cost effective to manufacture.

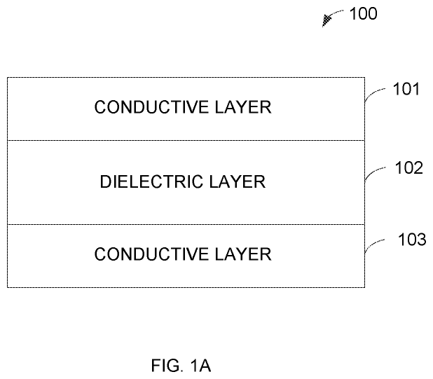

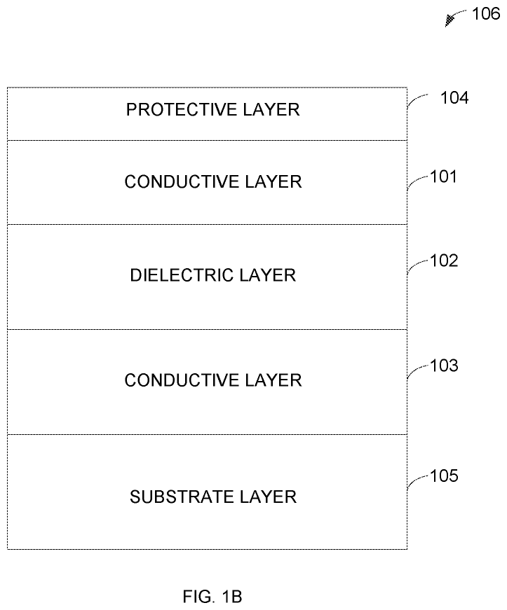

FIGS. 1A and 1B are block diagrams illustrating examples of cross section views of a layered RFID tag. FIG. 1A is a block diagram illustrating one example of a cross section view of a layered resonator portion 100 of an RFID tag. The resonator portion 100 includes a conductive layer 101, a dielectric layer 102, and a conductive layer 103. The conductive layers 101 and 103 may be created from any suitable conductive material, such as CNT or metal alloy material. The metal allow may be, for example, nickel or iron. The conductive layers 101 and 103 may be created from the same or different conductive materials. In one implementation the conductive layer 101 includes a metal trace. The conductive layer 101 may include a metal trace that includes conductive portions and non-conductive portions, such as where the metal trace is in a spiral configuration.

The dielectric layer 102 may be created from titanium oxide or other dielectric material. The dielectric layer 102 may separate the conductive layer 101 and the conductive layer 103 such that there is not an electrical component for communicating between the conductive layers 101 and 103. The dielectric layer 102 may be made from multiple materials, such as where a first segment of the dielectric layer 102 is composed of a first material and a second segment of the dielectric layer is composed of a second material. The dielectric layer 102 may be any suitable thickness. In one implementation, different segment of the dielectric layer 102 have different thicknesses. In one implementation, different segments of may be both different materials and thicknesses. The material and thickness at different segments may be selected to achieve a target electromagnet resonance of the RFID tag.

The conductive layer 103 may include a transmission line, such as a transmission line to communicate between two antennae. The conductive layer 101 may be positioned such that the transmission line of conductive layer 103 and a resonator of the conductive layer 101 are separated by the dielectric layer 102.

A signature electromagnetic resonance may be created by the resonator portion 100, such as based on the position, size, gap spacing, and/or number of the resonators in the conductive layer 100 and the thickness of the dielectric layer 102. Information about the signature electromagnetic resonance may be stored such that an object with an RFID tag with the signature electromagnetic resonance may be identified based on a comparison of the electromagnetic resonance of the RFID tag to the stored electromagnetic resonance information.

FIG. 1B is a block diagram illustrating one example of a cross section view of a layered RFID tag 106. The RFID tag 106 includes the resonator portion 100 with the conductive layers 101 and 103 and dielectric layer 102. The RFID tag 106 includes a protective layer 104, such as a layer to prevent damage to the conductive layer 101. For example, the protective layer 104 may improve the durability of the underlying layers. The protective layer 104 may be created from any suitable material, such as a transparent or opaque protective coating material. For example, the protective layer 104 may be an OPV (over print varnish) coating, UV coating with matte or gloss finishes, electrically insulating coating, dielectric coating, and/or aqueous coating. The protective layer 104 may include multiple layers and type of coatings. The protective layer 104 may cover the conductive layer 101 and in some implementations may extend beyond the conductive layer 101. For example, the protective layer 104 may cover the conductive layer 101 in addition to a portion of a package or other item that the RFID tag 106 is attached to.

The RFID tag 106 includes a substrate layer 105. The substrate layer 105 may be any suitable media substrate, such as packaging. The substrate layer 105 may be, for example, paper (e.g., kraft paper, sulfite paper, and/or greaseproof paper), plastic (e.g., polyolefin, polyester, polyethylene terephthalate, and polyvinyl chloride), and/or single or multi-layer paperboards (e.g., white board, solid board, chipboard, fiber board, and/or corrugated cardboard).

The substrate layer 105 may form part of a package or other item tracked with the RFID tag 106. For example, the RFID may be printed directly on the packaging of an item or the item itself. In some implementations, there are additional layers between the substrate layer 105 and the conductive layer 103. For example, there may be an insulating layer directly adjacent to the substrate layer 105 between the substrate layer 105 and the conductive layer 103.

The RFID tag 106 may include additional layers, such as additional conductive layers separated by additional dielectric layers. The RFID tag 106 may include additional layers of other materials.

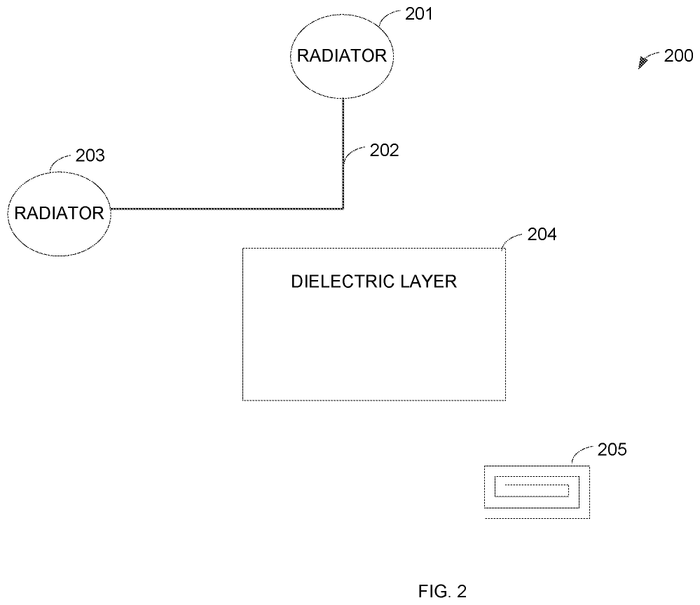

FIG. 2 is a diagram illustrating an exploded view of an RFID tag 200. The RFID tag 200 includes radiators 201 and 203. The radiators 201 and 203 may be, for example, antennae, such as where radiator 201 is an Rx antenna and radiator 203 is a Tx antenna. In one implementation, the radiators 201 and 203 are replaced by a single dipole antenna.

A transmission line 202 may connect the radiators 201 and 203. The transmission line 202 may be created from a conductive material and correspond to the conductive layer 103 of FIG. 1A.

A dielectric material 204 may be positioned adjacent to a surface of the transmission line 202 such that the dielectric material 204 forms a dielectric layer covering a surface of the transmission line 202. The dielectric material 204 may correspond to the dielectric layer 102 of FIG. 1A.

A resonator 205 may be positioned adjacent to a surface of the dielectric material 204 opposite of the surface of the dielectric material 204 adjacent to the transmission line 202 such that the dielectric material 204 is between the resonator 205 and the transmission line 202. The resonator 205 may be created from a conductive material and may correspond to the conductive layer 101 of FIG. 1A. The resonator 205 may be positioned such that it is separated from the transmission line 202 by the dielectric material 204. The resonator 205 may be any suitable resonator. In one implementation, the resonator 205 is a spiral resonator. For example, the resonator 205 may include conductive material in a ring formation. The ring formation may be in a spiral configuration such that a continuous track of conductive material is formed in a two-dimensional spiral pattern. The resonance frequency for each of the rings within the spiral pattern may be dependent on the width of the conductive track and the radius of the particular ring. The configuration of the conductive track may create a specific electromagnetic signature in the frequency domain that is to be used for RFID reading/detection. For example, a different configuration may be used for different RFID tags to alter the signature electromagnetic resonance.

The RFID tag 200 may include multiple resonators, such as multiple spiral resonators separated from the transmission line 202 by the dielectric material 204. The number and position of the resonators may be selected based on a target electromagnetic resonance. For example, the conductive layer including the resonator 205 may include additional resonators to achieve a target electromagnetic resonance for a particular RFID tag.

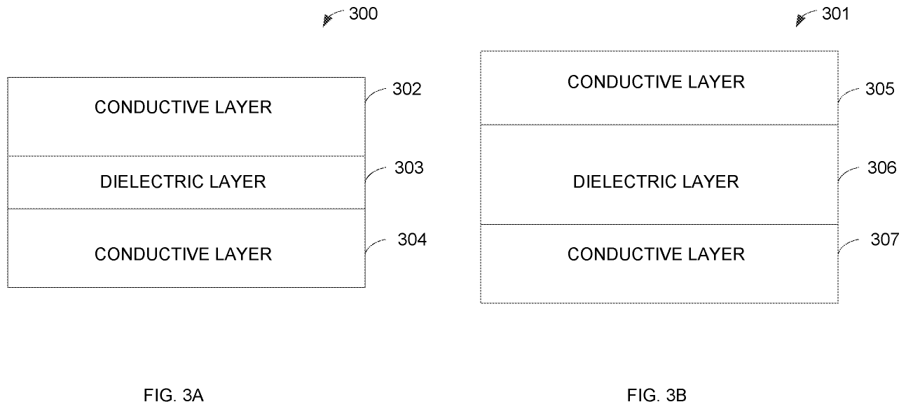

FIGS. 3A and 3B are diagrams illustrating examples of layered RFID tags with layers of different thicknesses. FIG. 3A illustrates a cross section view of an RFID tag 300, and FIG. 3B illustrates a cross section view of an RFID tag 301. The RFID tags 300 and 301 may include dielectric layers of different thicknesses. For example, a dielectric layer 303 between conductive layers 302 and 304 associated with the RFID tag 300 may have a smaller thickness than a dielectric layer 306 between conductive layers 305 and 306 of the RFID tag 301. For example, the distance between the conductive layers 302 and 304 may be smaller than the distance between the conductive layers 305 and 306 due to a thinner dielectric layer 303.

The dielectric layer 303 thickness may be selected based on a target electromagnetic resonance of the RFID tag 300. The increased thickness of dielectric layer 306 between conductive layers 305 and 307 allows the electromagnetic resonance of the RFID tag 301 to be different than the electromagnetic resonance of RFID tag 300 in cases where the conductive trace of the RFID tag 300 and the conductive trace of the RFID tag 301 is otherwise the same. For example, the electromagnetic resonance of the RFID tag 300 and 301 may differ even though the configuration of a spiral resonator is the same for both the RFID tag 300 and 301.

A printer for printing the RFID tags 300 and 301 may use the same process with the variability limited to the thickness of the dielectric layers 302 and 306. In one implementation, the materials for the dielectric layers 303 and 306 are different to result in different electromagnetic resonances of the RFID tags 300 and 301. For example, both the depth and material may differ between RFID tags to achieve different target electromagnetic resonances.

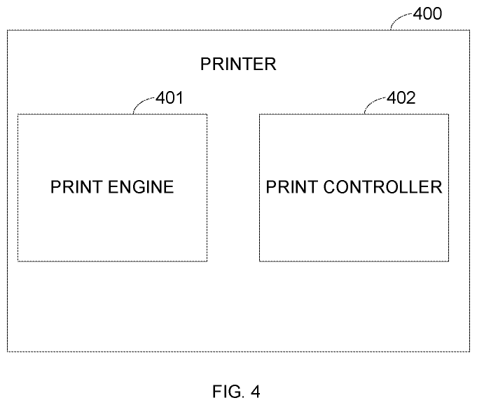

FIG. 4 is a block diagram illustrating one example of a printer to print a layered RFID tag. The printer 400 includes a print engine 401 and a print controller 402. The printer 400 may be any suitable printer for printing conductive and dielectric materials. The printer 400 may print using ink jet technology. In one implementation, the printer 400 is a liquid electro-photophraphic (LEP) printer.

The print engine 401 may be any suitable print engine to create conductive and dielectric layers, such as by depositing material in a layerwise manner. The print engine 401 may be associated with a liquid electro-photographic (LEP) printer. For example, the print engine 401 may include a photoreceptor and charging element. The charging element may be a charge roller or other component that generates a charge to cover the photoreceptor surface with an electrostatic charge. The print engine 401 may include a laser imaging unit to expose image areas on the photoreceptor by dissipating the charge in those areas of the photoreceptor. Exposure of the photoreceptor may create a latent image in the form of an invisible electrostatic charge pattern that replicates the conductive trace of a resonator to be printed as part of an RFID tag. The electrostatic conductive trace image formed on the photoreceptor may be developed by a binary ink development (BID) roller to form the conductive ink image on the outer surface of the photoreceptor. The BID roller may also include dielectric ink formulations to be developed on the photoreceptor, which may be included in non-conductive portions of a conductive layer and may be used to form a dielectric layer. The image may be transferred from the photoreceptor using a transfer blanked and transferred to a substrate, such as a packaging substrate.

The print controller 402 may control the print engine 401 to print different materials onto different layers of an RFID tag. For example, the print controller 402 may determine a conductive trace pattern to print on a conductive layer, a material of a conductive layer, a thickness of a dielectric layer, and/or material of a dielectric layer. The print controller 402 may include a processor and a memory to control printing of an RFID tag by the print engine 401.

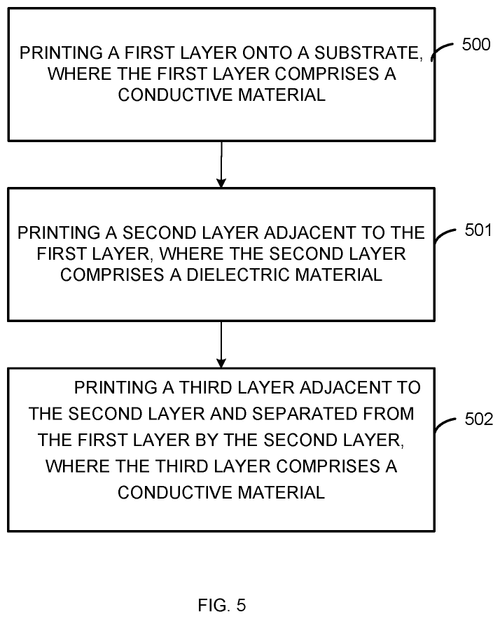

FIG. 5 is a flow chart illustrating one example of a method to print a layered RFID tag. The method may be implemented by the printer 400 of FIG. 4. For example, the method to print the layered RFID tag may use a liquid electro-photographic (LEP) printing process. The RFID tag may be printed in a layered method such that a first material is deposited on top of a second material to form multiple layers.

Beginning at 500, a printer prints a first layer onto a substrate, such as by printing a conductive material onto a substrate. The first layer may include a transmission line for communicating between two antennae, such as between Tx and Rx antennas associated with an RFID tag. The printer may determine a target position and material for the conductive material.

Continuing to 501, the printer prints a second layer adjacent to the first layer, such as by printing a dielectric material on top of the first layer. In one implementation, the printer determines a target depth and target material of the second dielectric layer based on a target electromagnetic resonance of the RFID tag. For example, the material and depth may be adjusted to create the signature electromagnetic resonance of the RFID tag being printed. Information about the signature electromagnetic resonance of the RFID tag may be stored to be used for later identification or tracking.

Continuing to 502, the printer prints a third layer adjacent to the second layer and separated from the first layer by the second layer. The third layer may be created by printing a conductive material. For example, the third layer may include a conductive trace with multiple spiral resonators. The spiral resonators may be printed with conductive printing fluid, such as electro ink.

The printer may print a fourth layer adjacent to the third layer such that the fourth layer forms a protective coating over the third layer. In one implementation, the fourth layer is attached to the third layer in a process separate from the printing process. A layered passive chipless RFID tag with two conductive layers separated by a dielectric layer may be created that allows for more design and manufacturing flexibility and lower cost.

1. A method, comprising:
printing a first layer onto a substrate, wherein the first layer comprises a conductive material;
printing a second layer adjacent to the first layer, wherein the second layer comprises a dielectric material; and
printing a third layer adjacent to the second layer and separated from the first layer by the second layer, wherein the third layer comprises a conductive material,
wherein the three layers form a portion of a chipless passive RFID tag.

2. The method of claim 1, wherein printing the third layer comprises printing multiple spiral resonators.

3. The method of claim 2, wherein printing a spiral resonator comprises printing with electro ink.

4. The method of claim 1, further comprising determining information about a target thickness of the second layer dielectric layer based on a target electromagnetic resonance of the RFID tag.

5. The method of claim 1, comprising printing the RFID tag with a first thickness of the second layer and printing a second RFID tag with a second thickness of the second layer.

6. The method of claim 1, further comprising selecting the material for the second layer based on a target electromagnetic resonance of the RFID tag.

7. The method of claim 1, wherein printing the first layer comprises printing the first layer using a liquid electro-photographic printing process.

8. The method of claim 1, wherein printing the first layer comprises printing a transmission line.

9. An RFID tag, comprising:
a first conductive layer,
a second dielectric layer, and
a third conductive layer,
wherein the first, second, and third layers are in a stacked configuration with the second layer between the first layer and the second layer, and
wherein the RFID tag is a passive chipless RFID tag.

10. The RFID of claim 9, wherein a first segment of the second dielectric layer between a first segment of the first conductive layer and a first segment of the third conductive layer comprises a first thickness and wherein a second segment of the second dielectric layer between a second segment of the first conductive layer and a second segment of the third conductive layer comprises a second thickness.

11. The RFID of claim 9, wherein a first segment of the second dielectric layer between a first segment of the first conductive layer and a first segment of the third conductive layer comprises a first material and wherein a second segment of the second dielectric layer between a second segment of the first conductive layer and a second segment of the third conductive layer comprises a second material.

12. The RFID tag of claim 9, wherein the first conductive layer includes a transmission line.

13. The RFID tag of claim 12, wherein the transmission line connects a first and second antenna.

14. An RFID tag, comprising:
a first conductive layer communicating with a first radiator;
a second conductive layer including a resonator; and
a dielectric layer between the first conductive layer and the second conductive layer,
wherein the RFID tag comprises a passive chipless RFID tag without an electrical connection between the first conductive layer and the second conductive layer.

15. The RFID tag of claim 14, wherein the second conductive layer includes multiple spiral resonators.
